(19) United States
(12) Patent Application Publication
(10) Pub. No.: US 2003/0144412 A1
(43) Pub. Date: Jul. 31, 2003

(54) Polyurethane compositions

(76) Inventors: Akihiro Miyata, Kanagawa Prefecture (JP); Kazunori Ishikawa, Kanagawa Prefecture (JP); Kiminori Araki, Kanagawa Prefecture (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/329,509

(22) Filed: Dec. 27, 2002

(30) Foreign Application Priority Data
Dec. 27, 2001 (JP) 2001-397124

(51) Int. Cl. C08K 3/00

(52) U.S. Cl. 524/589

(57) ABSTRACT

The present invention provides an one-pack moisture curable polyurethane composition that prevents an increase in functionality and a decrease in stability of a conventional one-pack moisture curable polyurethane composition and that has excellent adhesion onto glass, metals, plastics, coated steel plates, etc., even without using a primer and further has good curability and good heat resistant adhesion. An one-pack moisture curable polyurethane composition is disclosed, which contains a compound A, which is a reaction product of a polyisocyanate having at least one member selected from the group consisting of a biuret group and an isocyanurate group with a secondary aminoalkoxysilane having an aromatic ring with a predetermined structure directly bonded to the nitrogen atom thereof and which has at least one isocyanate group and at least one hydrolyzable alkoxysilyl group in one molecule and which has an average molecular weight of below 2,000; and a urethane prepolymer B having an average molecular weight of 2,000 or more and having an isocyanate group.

### BACKGROUND OF THE INVENTION

1. Field of the Invention

The present invention relates to one-pack moisture curable polyurethane compositions and more particularly to one-pack moisture curable polyurethane compositions having excellent adhesion to glass, metals, plastics, coated steel plates, etc. even without using a primer.

2. Related Background Art

Hitherto, various types of polyurethane compositions have found a variety of uses as sealing materials, adhesives, etc. As such polyurethane compositions have been known as those compositions of a two-pack type which comprise a polyol compound and an isocyanate compound, and those compositions of one-pack type which cure with moisture in the air, etc. In recent years, one-pack moisture curable polyurethane compositions have found an increasing range of uses because of nonnecessity of controlled mixing of the composition in situ working, ease of handling, etc.

As for the one-pack moisture curable polyurethane composition, for example, U.S. Pat. No. 4,374,237 A discloses a polyurethane sealant containing a prepolymer having two or more alkoxysilyl groups in the molecule obtained by the reaction between a urethane prepolymer with secondary aminosilane, and U.S. Pat. No. 4,687,533 A discloses a sealant containing a urethane prepolymer having an alkoxysilane as a pendant group. However, these polyurethane sealants cure slowly and thus have a problem on safety in use, for example, for bonding window glass for automobiles to the body of an automobile. Also, the sealants have insufficient physical properties for structural members.

Also, JP 6-212141 A discloses urethane compositions having blended therewith isocyanate silane or the like obtained by the reaction of an isocyanurate-form derivative, biuret-form derivative or-pentaerythritol adduct of hexamethylene diisocyanate (HDI) with mercaptosilane. However, these functional groups have low reactivity so that catalysts and heating were required at the time of synthesizing the isocyanate silanes. Therefore, there is a possibility that the resulting isocyanate silanes further react with each other, likely resulting in an increase in functionality and in a decrease in stability of the resin. In addition, in the case of pentaerythritol adduct of HDI, its functionality is too high to be free of the problem that the physical properties of cured products become brittle when the adduct is blended in large amounts in the composition.

Furthermore, U.S. Pat. No. 5,623,044 A discloses polyurethane sealants containing reaction products between a secondary aminosilane and a polyisocyanate such as isophorone diisocyanate trimer, biuret-modified product of hexamethylene diisocyanate, or polyphenyl polymethylene isocyanate. Although the polyurethane sealants containing these reaction products have good adhesion to glass, they have the problem that their adhesion to coating compositions, etc., the heat-resistant adhesion in particular, is insufficient.

Furthermore, JP 9-32239 A discloses a method of decorating an outer wall material by sticking tiles and discloses therein one-pack moisture curable urethane adhesives having blended therein a urethane prepolymer obtained from a tri-functional or other polyol and a polyisocyanate compound as well as an amino- or glycidyl silane coupling agent, etc.

On the other hand, one-pack moisture curable urethane compositions, as known in the art, have a problem in that they generate carbon dioxide by the reaction between free isocyanate in the urethane prepolymer and water upon curing reaction and they cause foaming. Particularly, under high temperature and high humidity conditions, there was a problem that the tendency of such urethane compositions to foam becomes greater so that they are difficult to use for applications in which they are exposed to high temperature and high humidity conditions in the stage of curing (for example, sealing materials, sealants for automobiles, etc.).

Therefore, realization of polyurethane sealants which solve the various problems described above and that have excellent adhesion onto glass, metals, plastics, coated steel plates, etc. even without using a primer has been desired.

Accordingly, as an one-pack moisture curable polyurethane composition having excellent adhesion to glass, resins, metals or the like, even without using a primer and further having good elongation, good curability and good antifoaming property, the inventors of the present invention have previously proposed the one-pack moisture curable polyurethane composition contains (A) a urethane prepolymer and (B) at least one silane compound selected from the group consisting of (B-1) a silane compound which is an adduct of a polyisocyanate compound which in turn is a reaction product of a tri- or polyol having a molecular weight of 500 or less with a diisocyanate and having at least three NCO groups in one molecule to a secondary aminoalkoxysilane and (B-2) a silane compound having a lysine skeleton which is an adduct of lysine isocyanate having two or three isocyanate groups to a secondary aminoalkoxysilane, and having 1.5 or more NCO groups on the average in one molecule and 1.5 or more hydrolyzable alkoxy groups in one molecule on the average (see JP 2000-128949 A).

### SUMMARY OF THE INVENTION

The inventors of the present invention have made extensive studies on the adhesion after heat aging (hereinafter, also referred to as “heat-resistant adhesion”) of one-pack moisture curable polyurethane composition as described in JP 2000-128949 A and as a result found a room for improving it.

Therefore, an object of the present invention is to provide an one-pack moisture curable polyurethane composition that prevents an increase in functionality and a decrease in stability of a conventional one-pack moisture curable polyurethane composition and that has excellent adhesion onto glass, metals, plastics, coated steel plates, etc., even without using a primer and further has good curability and good heat resistant adhesion.

The inventors of the present invention have found that an one-pack moisture curable polyurethane composition which contains a urethane prepolymer and a reaction product of a specific secondary aminoalkoxysilane with a polyisocyanate is suitable as a non-primer polyurethane sealant for use in bonding various materials such as glass, metals, plastics, and coated steel plates, thereby accomplishing the present invention.

Therefore, according to the present invention, there is provided an one-pack moisture curable polyurethane composition including:

a compound A, which is a reaction product of a polyisocyanate having at least one member selected from the group consisting of a biuret group and an isocyanurate group with a secondary aminoalkoxysilane having an aromatic ring directly bonded to the nitrogen atom thereof, represented by formula (1) shown below

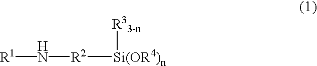

(wherein R¹ is an aromatic residue; R² is an alkylene group, which may be branched, having 1 to 18 carbon atoms; R³ and R⁴ are independently an alkyl group, which may be branched, having 1 to 18 carbon atoms; n is an integer of from 1 to 3, provided that plural (R³)s or (R⁴)s may be the same or different) and which has at least one isocyanate group and at least one hydrolyzable alkoxysilyl group in one molecule and which has an average molecular weight of below 2,000; and

a urethane prepolymer B having an average molecular weight of 2,000 or more and having an isocyanate group.

According to the present invention, there is provided the aforementioned one-pack moisture curable polyurethane composition characterized by containing 0.1 to 15 parts by weight of the aforementioned compound A per 100 parts by weight of the aforementioned urethane prepolymer B.

Furthermore, the present invention provides a sealing material containing the above-mentioned polyurethane composition.

### DETAILED DESCRIPTION OF THE INVENTION

Hereinafter, the one-pack moisture curable polyurethane composition of the present invention (hereinafter, referred to as “inventive polyurethane composition”) will be described in detail.

The inventive polyurethane composition is an one-pack moisture curable polyurethane composition which contains a compound A which is a reaction product of a polyisocyanate having at least one member selected from the group consisting of a biuret group and an isocyanurate group with a secondary aminoalkoxysilane having an aromatic ring directly bonded to the nitrogen atom thereof, represented by the formula (1) above, and which has at least one isocyanate group and at least one hydrolyzable alkoxysilyl group in one molecule and having an average molecular weight of below 2,000; and

a urethane prepolymer B having an average molecular weight of 2,000 or more and having an isocyanate group.

The above-mentioned polyisocyanate is a compound having at least one group selected from a biuret group and an isocyanurate group, preferably having an average molecular weight of 2,000 or less, and more preferably 1,500 or less.

Specific examples of the above-mentioned polyisocyanate include 2,4-tolylene diisocyanate (2,4-TDI), 2,6-tolylene diisocyanate (2,6-TDI), 4,4′-diphenylmethane diisocyanate (4, 4′-MDI), 2,4′-diphenylmethane diisocyanate (2,4′-MDI), and modified derivatives thereof; biuret-form derivatives and/or isocyanurate-form derivatives of polyisocyanates exemplified by 1,5-naphthalene diisocyanate (NDI), tolidine diisocyanate (TODI), hexamethylene diisocyanate (HDI), isophorone diisocyanate (IPDI), xylene diisocyanate (XDI), 1,4-phenylene diisocyanate, transcyclohexane-1,4-diisocyanate, lysine diisocyanate, triphenylmethane triisocyanate, tris(isocyanatephenyl) thiophosphate, tetramethylxylene diisocyanate (TMXDI), lysine ester triisocyanate, 1,6,11-undecane triisocyanate, 1,3,6-hexamethylene triisocyanate, bicycloheptane triisocyanate, trimethylhexamethylene diisocyanate (TMDI), etc. The isocyanurate-form derivative of HDI represented by formula (2) shown below and the biuret-form derivative of HDI represented by formula (3) shown below are preferably exemplified.

As the polyisocyanate described above, the exemplified various polyisocyanates may be used alone or two or more of them may be used in combination. Furthermore, reaction products of the exemplified various polyisocyanates with polyol compounds may also be used. Also, the polyisocyanate described above may be those derivatives containing the biuret-form derivative and/or isocyanurate-form derivatives of the exemplified various polyisocyanates.

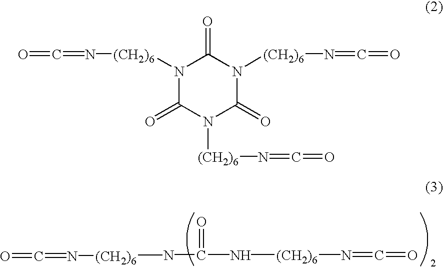

The above-mentioned secondary aminoalkoxysilane is a compound which has a structure in which an aromatic ring is directly bonded to the nitrogen atom thereof as represented by the formula (1) above and has a secondary amino group and an alkoxysilyl group in the molecule.

In the formula (1) shown above, R¹ is an aromatic residue, specific examples of which include a phenyl group, a p-toluyl group, etc.; R² is an alkylene group, which may be branched, having 1 to 18 carbon atoms, preferably having 2 to 6 carbon atoms; R³ and R⁴ are independently an alkyl group, which may be branched, having 1 to 18 carbon atoms, preferably having 1 to 3 carbon atoms and more preferably a methyl group or an ethyl group; n is an integer of 1 to 3, provided that plural (R³)s or (R⁴)s may be the same or different. Here, the above-mentioned alkylene group and the above-mentioned alkyl group may either be linear or be branched or contain one or more heteroatoms (O, N, S, etc.).

Further, the above-mentioned secondary aminoalkoxysilane has a rigid structure due to the presence of an aromatic ring directly bonded to the nitrogen atom thereof, so that the inventive polyurethane composition having blended therein the secondary aminoalkoxysilane exhibits excellent heat-resistant adhesion to glass, metals, plastics, coated steel plates, etc.

Specifically, one preferred example of such secondary aminoalkoxysilane is y-phenylaminopropyltrimethoxysilane (trade name: Y-9669 (manufactured by Nippon Unicar Company, Limited.)) represented by the following formula (4).

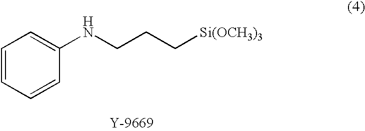

The above-mentioned compound A is an isocyahate silane compound, which is a reaction product of the above-mentioned polyisocyanate with the above-mentioned secondary aminoalkoxysilane. Here, the compound A has at least one isocyanate (NCO) group on the average in one molecule and at least one hydrolyzable alkoxysilyl group on the average in one molecule, preferably at least one isocyanate (NCO) group on the average in one molecule and at least two hydrolyzable alkoxysilyl groups on the average in one molecule, and more preferably at least one isocyanate (NCO) group on the average in one molecule and at least three hydrolyzable alkoxysilyl groups on the average in one molecule.

Furthermore, the compound A has an average molecular weight of below 2,000, preferably from 600 to 1,800, and more preferably from 600 to 1,500.

The reaction of the above-mentioned polyisocyanate and secondary aminoalkoxysilane is carried out in the way that the ratio of isocyanate group/amino group, i.e., the ratio of isocyanate in the polyisocyanate per one amino group in the secondary aminoalkoxysilane (hereinafter, referred to as “NCO/NH”) will be from 1.5/1.0 to 9.0/1.0, preferably from 1.5/1.0 to 6.0/1.0. In this instance, unreacted polyisocyanate may remain. The NCO/NH ratios within the above-mentioned ranges are preferred, since the compound A exhibits sufficient heat-resistant adhesion improving effect in such a condition.

The compound A can be produced in the same manner as in the production of conventional polyurethanes; for example, it can be produced by stirring, a mixture of the polyisocyanate and secondary aminoalkoxysilane in the above-mentioned equivalent ratios at ambient temperature. Optionally, urethanation catalysts such as organotin compounds, organobismuth compounds, and amines may also be used.

The above-mentioned urethane prepolymer B, which has a free isocyanate group, may be those used in conventional one-pack polyurethane compositions and it is a reaction product of a polyol compound with an excess polyisocyanate compound(that is, excess isocyanate group with respect to OH group). In addition, the above-mentioned urethane prepolymer B has an average molecular weight of 2,000 or more, preferably from 2,000 to 15,000, and more preferably from 2,000 to 10,000.

Here, the “polyol compound” is a generic name of polyhydroxy compounds having a structure obtainable by replacing a plurality of hydrogens existent on a hydrocarbon by hydroxyl groups. Specifically, the polyol compound is a product of addition polymerization of one or more alkylene oxides such as, for example, ethylene oxide, propylene oxide, butylene oxide and tetrahydrofuran, to a compound having two or more active hydrogens.

Specific examples of the compound having two or more active hydrogens that can be used include ethylene glycol, propylene glycol, butanediol, diethylene glycol, glycerol, hexanetriol, trimethylolpropane, pentaerythritol, etc. and further polyhydric alcohols, e.g., polyether polyols such as polytetramethylene glycol, polyethylene glycol, polypropylene glycol, polyoxypropylenediol, polyoxypropylenetriol, and polyoxybutylene glycol; polyolefin polyols such as polybutadienepolyol and polyisoprene glycol; adipate polyols; lactone polyols; polyester polyols such as castor oil, and also polyhydric phenols such as resorcinol and bisphenol.

As the above-mentioned polyol compound, the exemplified various polyol compounds may be used alone or two or more of them may be used in combination. In any of these instances, desirably each polyol compound has an average molecular weight of 500 to 10,000, preferably from 1,000 to 10,000, and more preferably from 2,000 to 10,000.

As the polyisocyanate compound that generates the urethane prepolymer B, those used in conventional one-pack polyurethane compositions may be employed and the above-mentioned polyisocyanates may be used. Specifically, suitable examples of such a polyisocyanate compound include aromatic polyisocyanates such as 2,4-tolylene diisocyanate (2,4-TDI), 2,6-tolylene diisocyanate (2,6-TDI), 4,4′-diphenylmethane diisocyanate (4,4′-MDI), 2,4′-diphenylmethane diisocyanate (2,4′-MDI), 1,4-phenylene diisocyanate, 1,5-naphthalene diisocyanate, and triphenylmethane triisocyanate, and hydrogenated compounds thereof; aliphatic polyisocyanates such as ethylene diisocyanate, propylene diisocyanate, tetramethylene diisocyanate, and hexamethylene diisocyanate; alicyclic polyisocyanates such as isophorone diisocyanate; aryl-aliphatic polyisocyanates such as xylylene diisocyanate, and hydrogenated compounds thereof, and the like. These may be used alone or in combinations of two or more of them.

The above-mentioned urethane prepolymer B can be produced by reacting the polyol compound described above with an excess amount of the polyisocyanate compound so that the ratio of isocyanate group/hydroxyl group, i.e., the ratio of isocyanate group in the polyisocyanate compound per one hydroxyl group in the polyol compound will be from 1.2/1.0 to 2.5/1.0, preferably from 1.5/1.0 to 2.4/1.0. The NCO/OH ratios within the above-mentioned ranges are preferred since the obtained urethane prepolymer B will have suitable viscosities.

Furthermore, the above-mentioned urethane prepolymer B can be produced in the same manner as in the production of the conventional urethane prepolymers; for example, it can be produced by stirring a mixture of the polyol compound and polyisocyanate compound in the above-mentioned equivalent ratios with heating at 50 to 100° C. Optionally, urethanation catalysts such as organotin compounds, organobismuth compounds and amines may also be used.

Furthermore, the obtained urethane prepolymer B preferably has 2.0 or more isocyanate groups on the average in one molecule and more preferably has 2.1 or more isocyanate groups on the average in one molecule. Expressed differently, the isocyanate content (NCO %) of the urethane prepolymer B is preferably 0.3% or more, and more preferably 0.5% or more, assuming that NCO % means % by weight (wt. %) of isocyanate group to the total weight of the urethane prepolymer.

It is preferred that the urethane prepolymer B has NCO % within the above-mentioned ranges since the obtained polyurethane composition of the present invention has excellent viscosity, adhesion and characteristics as a sealant after curing (for example, hardness and modulus).

The inventive polyurethane composition is an one-pack moisture curable polyurethane composition which includes a isocyanate silane compound (compound A) which is a reaction product of the above-mentioned secondary aminoalkoxysilane with the polyisocyanate in addition to the above-mentioned urethane prepolymer B.

The inventive polyurethane composition preferably contains the compound A in an amount of 0.1 to 15 parts by weight, more preferably from 0.2 to 10 parts by weight, and still more preferably from 0.2 to 5 parts by weight, per 100 parts by weight of the urethane prepolymer B. When the content of compound A is in the above-mentioned ranges, the obtained polyurethane composition when used as a sealing material advantageously has excellent adhesion and excellent heat-resistant adhesion.

Inorganic fillers, plasticizers, etc. may be added to the inventive polyurethane composition as far as they do not harm the object of the present invention in order to make sealing materials and adhesive compositions from the composition.

Specific examples of the inorganic filler that can be used in the present invention include calcium carbonate, clay, talc, silica, carbon black, etc.

Any plasticizers that are inactive to isocyanate group may be used. Generally, dibutyl phthalates, dioctyl phthalates, tetrahydrophthalates, azelates acid, maletes, phthalates, trimellitates, adipates, etc. are used.

The inventive polyurethane composition may contain besides the above-mentioned essential components, curing catalysts, other fillers, thixotropic agents, pigments, dyes, antiaging agents, antioxidants, antistatic agents, flame retardants, tackifiers, dispersants, solvents, etc. as far as they do not harm the effects of the present invention. Specific examples of the curing catalyst include dioctyltin dilaurate, dibutyltin laurate, tin octylate, led octylate, tertiary amines, etc. Solvents that can be used include toluene, xylene, hexane, heptane, etc.

The production method for the inventive polyurethane composition is not particularly limited. For example, the composition can be obtained by mixing the above-mentioned compound A, the above-mentioned urethane prepolymer B, and optionally a filler, a plasticizer and other additives, and sufficiently kneading the resulting mixture in a mixer such as a ball mill to make an uniform dispersion.

The inventive polyurethane composition having such a construction is useful since it has excellent adhesion to a variety of materials. This would be attributable to high adhesion to glass or substrates made of silicones given by silyl groups and to high adhesion to acrylic coated surfaces given by isocyanate groups; the inventive polyurethane composition having a silyl group and an isocyanate group has very excellent adhesion to both types of materials.

Furthermore, the secondary aminoalkoxysilane has a rigid structure since R¹ in the formula (1) shown above represents an aromatic residue, which is considered to contribute to high adhesion and high heat-resistant adhesion exhibited by the resulting polyurethane composition to glass, metals, plastics, coated steel plates, etc.

Also, failure of the compound disclosed in JP 2000-128949 A (the compound of the formula (5) shown below) to exhibit such effects indicates the superiority of the inventive polyurethane composition.

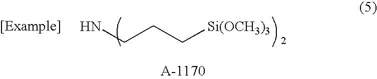

Hereinafter, the present invention will be described in detail by way of examples. However, the present invention should not be limited thereto.

<Synthesis of urethane prepolymer 1>

A mixture of 500 g of polyoxypropylenediol having an average molecular weight of 2,000, 750 g of polyoxypropylenetriol having an average molecular weight of 5,000, and 1,460 g of dioctyl phthalate as a plasticizer was dehydrated at 110° C. for 16 hours under reduced pressure and then 214 g of MDI was added to the dehydrated mixture so as to reach a state of NCO/OH=1.8. The resultant was allowed to react at 80° C. for 24 hours in nitrogen stream to obtain a polymer with an isocyanate group content of 1.1% by weight, which was named urethane prepolymer 1.

<Synthesis of Urethane Prepolymer 2>

A mixture of 400 g of polyoxypropylenediol having an average molecular weight of 2,000, 600 g of polyoxypropylenetriol having an average molecular weight of 4,000, and 510 g of isodecyl phthalate as a plasticizer was dehydrated at 110° C. for 16 hours under reduced pressure and then 186.6 g of MDI was added to the dehydrated mixture so as to reach a state of NCO/OH=1.75. The resultant was allowed to react at 80° C. for 24 hours in nitrogen stream to obtain a polymer with an isocyanate group content of 1.5% by weight, which was named urethane prepolymer 2.

<Synthesis of adducts 1-10>

An isocyanate silane compound which is a reaction product between a polyisocyanate and a secondary aminoalkoxysilane is also called an adduct. In Examples and Comparative Examples, adducts 1-10 described below were used. The obtained adducts 1-10 are shown in Table 1.

a) Adduct 1 (Isocyanurate-Form Derivative of HDI/Y-9669 Reaction Product (NCO/NH=3/1))

In a four-mouthed flask, 100 g of isocyanurate-form derivative of HDI (trade name: D170N; isocyanate group content 21.0%; manufactured by Takeda Pharmaceutical Co., Ltd.) and 28.6 g of diisononyl phthalate (trade name: DINP; manufactured by Shin Nippon Rika Co., Ltd.) (hereinafter abbreviated as “DINP”) were charged and stirred in N₂ stream while dripping 42.5 g of γ-phenylaminopropyltrimethoxysilane (trade name: Y-9669, manufactured by Nippon Unicar Company, Ltd.) (hereinafter abbreviated as “Y-9669”) so that the value of NCO/NH reached 3/1. In this manner, reaction was allowed to proceed at 40° C. for 4 hours to obtain adduct 1 (adduct concentration 83%). The obtained adduct 1 contained 2 isocyanate groups on the average in one molecule and 3 alkoxysilyl groups on the average in one molecule.

b) Adduct 2 (Isocyanurate-Form Derivative of HDI/Y-9669 Reaction Product (NCO/NH=3/1.5))

In a four-mouthed flask, 100 g of isocyanurate-form derivative of HDI (trade name: D170N; isocyanate group content 21.0%; manufactured by Takeda Pharmaceutical Co., Ltd.) and 33.5 g of DINP were charged and stirred in N₂ stream while dripping 63.8 g of Y-9669 so that the value of NCO/NH reached 3/1.5. In this manner, reaction was allowed to proceed at 40° C. for 4 hours to obtain adduct 2 (adduct concentration 83%). The obtained adduct 2 contained 1.5 isocyanate groups on the average in one molecule and 3 alkoxysilyl groups on the average in one molecule.

c) Adduct 3 (Biuret-Form Derivative of HDI/Y-9669 Reaction Product (NCO/NH=3/1))

In a four-mouthed flask, 100 g of biuret-form derivative of HDI (trade name: D165N; isocyanate group content 23.4%; manufactured by Takeda Pharmaceutical Co., Ltd.) and 30.2 g of DINP were charged and stirred in N₂ stream while dripping 47.4 g of Y-9669 so that the value of NCO/NH reached 3/1. In this manner, reaction was allowed to proceed at 40° C. for 4 hours to obtain adduct 3 (adduct concentration 83%). The obtained adduct 3 contained 2 isocyanate groups on the average in one molecule and 3 alkoxysilyl groups on the average in one molecule.

d) Adduct 4 (Biuret-Form Derivative of HDI/Y-9669 Reaction Product (NCO/NH=3/1.5))

In a four-mouthed flask, 100 g of biuret-form derivative of HDI (trade name: D165N; isocyanate group content 23.4%; manufactured by Takeda Pharmaceutical Co., Ltd.) and 35.0 g of DINP were charged and stirred in N₂ stream while dripping 71.0 g of Y-9669 so that the value of NCO/NH reached 3/1.5. In this manner, reaction was allowed to proceed at 40° C. for 4 hours to obtain adduct 4 (adduct concentration 83%). The obtained adduct 4 contained 1.5 isocyanate groups on the average in one molecule and 3 alkoxysilyl groups on the average in one molecule.

e) Adduct 5 (Isocyanurate-Form Derivative of IPDI/Y-9669 Reaction Product (NCO/NH 3/1))

In a four-mouthed flask, 100 g of isocyanurate-form derivative of IPDI (trade name: VESTANAT T-1890-100; isocyanate group content 15.3%; manufactured by Degussa Huls) and 100 g of DINP were charged and stirred in N₂ stream while dripping 31.0 g of Y-9669 so that the value of NCO/NH reached 3/1. In this manner, reaction was allowed to proceed at 40° C. for 4 hours to obtain adduct 5 (adduct concentration 57%). The obtained adduct 5 contained 2 isocyanate groups on the average in one molecule and 3 alkoxysilyl groups on the average in one molecule.

f) Adduct 6 (Isocyanurate-Form Derivative of IPDI/Y-9669 Reaction Product (NCO/NH=3/1.5))

In a four-mouthed flask, 100 g of isocyanurate-form derivative of IPDI (trade name: VESTANAT T-1890-100; isocyanate group content 15.3%; manufactured by Degussa Huls) and 100 g of DINP were charged and stirred in N₂ stream while dripping 46.5 g of Y-9669 so that the value of NCO/NH reached 3/1.5. In this manner, reaction was allowed to proceed at 40° C. for 4 hours to obtain adduct 6 (adduct concentration 59%). The obtained adduct 6 contained 1.5 isocyanate groups on the average in one molecule and 3 alkoxysilyl groups on the average in one molecule.

g) Adduct 7 (Isocyanurate-Form Derivative of HDI/A-1170 Reaction Product (NCO/NH=3/1))

In a four-mouthed flask, 100 g of isocyanurate-form derivative of HDI (trade name: D170N; isocyanate group content 21.0%; manufactured by Takeda Pharmaceutical Co., Ltd.) and 32.1 g of DINP were charged and stirred in N₂ stream while dripping 56.8 g of bis(trimethoxypropylamine) (trade name: A-1170; manufactured by Nippon Unicar Co., Ltd.) (hereinafter abbreviated as “A-1170”) so that the value of NCO/NH reached 3/1. In this manner, reaction was allowed to proceed at 40° C. for 4 hours to obtain adduct 7 (adduct concentration 83%). The obtained adduct 7 contained 2 isocyanate groups on the average in one molecule and 3 alkoxysilyl groups on the average in one molecule.

h) Adduct 8 (Biuret-Form Derivative of HDI/A-1170 Reaction Product (NCO/NH=3/1))

In a four-mouthed flask, 100 g of biuret-form derivative of HDI (trade name: D165N; isocyanate group content 23.4%; manufactured by Takeda Pharmaceutical Co., Ltd.) and 33.4 g of DINP were charged and stirred in N₂ stream while dripping 63.3 g of A-1170 so that the value of NCO/NH reached 3/1. In this manner, reaction was allowed to proceed at 40° C. for 4 hours to obtain adduct 8 (adduct concentration 83%). The obtained adduct 8 contained 2 isocyanate groups on the average in one molecule and 3 alkoxysilyl groups on the average in one molecule.

i) Adduct 9 (Pentaerythritol Adduct of HDI/Y-9669 Reaction Product (NCO/NH=2/1))

Ethyl acetate (270 g) was added to 136 g of pentaerythritol and 672 g of HDI and the resultant mixture was allowed to react at 80° C. to obtain HDI pentaerythritol adduct having an isocyanate group on the terminals thereof (isocyanate group content 14.5%).

In a four-mouthed flask, 100 g of the above-mentioned HDI pentaerythritol adduct was charged and stirred in N₂ stream while dripping 44.0 g of Y-9669 so that the value of NCO/NH reached 2/1. In this manner, reaction was allowed to proceed at 40° C. for 4 hours to obtain adduct 9 (adduct concentration 82%). The obtained adduct 9 contained 2 isocyanate groups on the average in one molecule and 6 alkoxysilyl groups on the average in one molecule.

j) Adduct 10 (HDI-PPG Adduct/Y-9669 Reaction Product (NCO/NH=3/1))

To a mixture of 1,000 g of dehydrated polyoxypropylenetriol having an average molecular weight of 2,000 and 500 g of dehydrated DINP, 252.3 g of HDI was added and the resultant mixture was allowed to react at 80° C. for 24 hours to obtain HDI-PPG adduct having an isocyanate group on the terminals thereof (isocyanate group content 3.6%).

In a four-mouthed flask, 100 g of the above-mentioned HDI-PPG adduct was charged and stirred in N₂ stream while dripping 7.3 g of Y-9669 so that the value of NCO/NH reached 3/1. In this manner, reaction was allowed to proceed at 40° C. for 4 hours to obtain adduct 10 (adduct concentration 71%). The obtained adduct 10 contained 2 isocyanate groups on the average in one molecule and 3 alkoxysilyl groups on the average in one molecule.

TABLE 1

| | Adduct | | | | | | | | | |
|---|---|---|---|---|---|---|---|---|---|---|
| | 1 | 2 | 3 | 4 | 5 | 6 | 7 | 8 | 9 | 10 |
| Polyisocyanate | HDI | HDI | HDI | HDI | IPDI | IPDI | HDI | HDI | HDI | HDI |
| | isocyanurate | isocyanurate | biuret | biuret | isocyanurate | isocyanurate | isocyanurate | biuret | pentaerythritol | PPG |
| | | | | | | | | | adduct | adduct |
| Aminoalkoxysilane | Y-9669 | Y-9669 | Y-9669 | Y-9669 | Y-9669 | Y-9669 | A-1170 | A-1170 | Y-9669 | Y-9669 |
| NCO/NH | 3/1 | 3/1.5 | 3/1 | 3/1.5 | 3/1 | 3/1.5 | 3/1 | 3/1 | 2/1 | 3/1 |
| Average number in | | | | | | | | | | |
| one molecule of | | | | | | | | | | |
| adduct | | | | | | | | | | |
| Isocyanate group | 2 | 1.5 | 2 | 1.5 | 2 | 1.5 | 2 | 2 | 2 | 2 |
| Alkoxysilyl group | 3 | 3 | 3 | 3 | 3 | 3 | 3 | 3 | 6 | 3 |

### EXAMPLES 1-30 AND COMPARATIVE EXAMPLES 1-4

To 100 parts by weight of the above-mentioned urethane prepolymer 1 and 2, carbon black, isononyl phthalate, dioctyltin dilaurate, dimethylaminoethylmorpholine (trade name: XDM; manufactured by Sankyo Air Products Co., Ltd.) and the above-mentioned adducts were added in formulations (parts by weight) shown in Table 2 shown below to obtain polyurethane compositions of Examples 1-30 and Comparative Examples 1-4, respectively. The adhesion of each of the obtained polyurethane compositions was examined under the conditions shown below. The results obtained are shown in Table 2.

<Measurement of Adhesion>

The adhesion of the polyurethane compositions of Examples 1-30 and Comparative Examples 1-4 was measured by the method described below. That is, each of the obtained polyurethane composition was coated on a plate glass to a thickness of 3 mm to obtain samples. Each sample was left to stand in an atmosphere at 20° C. and 65% RH for 7 days and then manual peeling tests by knife cutting were performed. Furthermore, samples that were left to stand in an atmosphere at 20° C. and 65% RH for 7 days were immersed in water at 40° C. for 14 days or held in an oven at 80° C. for 14 days, and subjected to manual peeling tests in the same manner as described above. As indices for expressing adhesion, cohesion failure CF of sealant (figure indicating ratio (%) to the bonded area) and adhesion failure AF of sealant (figure indicating ratio (%) to the bonded area) were used. CF 100% indicates that the composition layer concerned caused cohesion failure on the entire coated area but no peeling occurred on the bonded surface to glass. The results obtained are shown in Table 2.

TABLE 2

| | Example | | | | | | | | | |
|---|---|---|---|---|---|---|---|---|---|---|
| | 1 | 2 | 3 | 4 | 5 | 6 | 7 | 8 | 9 | 10 |
| Urethane prepolymer 1 | 100 | 100 | 100 | 100 | 100 | 100 | 100 | 100 | 100 | 100 |
| Adduct 1 | 0.24 | 0.6 | 1.8 | 3.0 | 6.0 | 12.0 | | | | |
| Adduct 2 | | | | | | | 0.24 | 0.6 | 1.8 | 6.0 |
| Carbon black | 100 | 100 | 100 | 100 | 100 | 100 | 100 | 100 | 100 | 100 |
| Isononyl phthalate | 45 | 45 | 45 | 45 | 45 | 45 | 45 | 45 | 45 | 45 |
| Dioctyltin dilaurate | 0.005 | 0.005 | 0.005 | 0.005 | 0.005 | 0.005 | 0.005 | 0.005 | 0.005 | 0.005 |
| Dimethylaminoethyl- | 0.02 | 0.02 | 0.02 | 0.02 | 0.02 | 0.02 | 0.02 | 0.02 | 0.02 | 0.02 |
| morpholine | | | | | | | | | | |
| Adhesion | | | | | | | | | | |
| 20° C. 65% RH × 7 days | CF100% | CF100% | CF100% | CF100% | CF100% | CF100% | CF100% | CF100% | CF100% | CF100% |
| 20° C. 65% RH × 7 days + | CF100% | CF100% | CF100% | CF100% | CF100% | CF100% | CF100% | CF100% | CF100% | CF100% |
| 40° C. in water for 14 days | | | | | | | | | | |
| 20° C. 65% RH × 7 days + | CF100% | CF100% | CF100% | CF100% | CF100% | CF100% | CF100% | CF100% | CF100% | CF100% |
| 80° C. in oven for 14 days | | | | | | | | | | |

| | Example | | | | | | | | |
|---|---|---|---|---|---|---|---|---|---|
| | 11 | 12 | 13 | 14 | 15 | 16 | 17 | 18 | 19 |
| Urethane prepolymer 1 | 100 | 100 | 100 | 100 | 100 | 100 | 100 | 100 | 100 |
| Adduct 3 | 0.24 | 0.6 | 1.8 | 6 | | | | | |
| Adduct 4 | | | | | 0.6 | 1.8 | | | |
| Adduct 5 | | | | | | | 0.9 | 2.5 | |
| Adduct 6 | | | | | | | | | 0.8 |
| Carbon black | 100 | 100 | 100 | 100 | 100 | 100 | 100 | 100 | 100 |
| Isononyl phthalate | 45 | 45 | 45 | 45 | 45 | 45 | 45 | 45 | 45 |
| Dioctyltin dilaurate | 0.005 | 0.005 | 0.005 | 0.005 | 0.005 | 0.005 | 0.005 | 0.005 | 0.005 |
| Dimethylaminoethylmorpholine | 0.02 | 0.02 | 0.02 | 0.02 | 0.02 | 0.02 | 0.02 | 0.02 | 0.02 |
| Adhesion | | | | | | | | | |
| 20° C. 65% RH × 7 days | CF100% | CF100% | CF100% | CF100% | CF100% | CF100% | CF100% | CF100% | CF100% |
| 20° C. 65% RH × 7 days + | CF100% | CF100% | CF100% | CF100% | CF100% | CF100% | CF100% | CF100% | CF100% |
| 40° C. in water for 14 days | | | | | | | | | |
| 20° C. 65% RH × 7 days + | CF100% | CF100% | CF100% | CF100% | CF100% | CF100% | CF100% | CF100% | CF100% |
| 80° C. in oven for 14 days | | | | | | | | | |

| | Example | | | | | | | | | | |
|---|---|---|---|---|---|---|---|---|---|---|---|
| | 20 | 21 | 22 | 23 | 24 | 25 | 26 | 27 | 28 | 29 | 30 |
| Urethane | 100 | 100 | 100 | 100 | 100 | 100 | 100 | 100 | 100 | 100 | 100 |
| prepolymer 2 | | | | | | | | | | | |
| Adduct 1 | 0.24 | 3 | 6 | 12 | | | | | | | |
| Adduct 2 | | | | | 0.24 | 6 | | | | | |
| Adduct 3 | | | | | | | 0.24 | 6 | | | |
| Adduct 5 | | | | | | | | | 0.9 | 2.5 | |
| Adduct 6 | | | | | | | | | | | 0.8 |
| Carbon black | 100 | 100 | 100 | 100 | 100 | 100 | 100 | 100 | 100 | 100 | 100 |
| Isononyl | 45 | 45 | 45 | 45 | 45 | 45 | 45 | 45 | 45 | 45 | 45 |
| phthalate | | | | | | | | | | | |
| Dioctyltin | 0.005 | 0.005 | 0.005 | 0.005 | 0.005 | 0.005 | 0.005 | 0.005 | 0.005 | 0.005 | 0.005 |
| dilaurate | | | | | | | | | | | |
| Dimethylamino- | 0.02 | 0.02 | 0.02 | 0.02 | 0.02 | 0.02 | 0.02 | 0.02 | 0.02 | 0.02 | 0.02 |
| ethylmorpholine | | | | | | | | | | | |
| Adhesion | | | | | | | | | | | |
| 20° C. 65% | CF100% | CF100% | CF100% | CF100% | CF100% | CF100% | CF100% | CF100% | CF100% | CF100% | CF100% |
| RH × 7 days | | | | | | | | | | | |
| 20° C. 65% | CF100% | CF100% | CF100% | CF100% | CF100% | CF100% | CF100% | CF100% | CF100% | CF100% | CF100% |
| RH × 7 days + | | | | | | | | | | | |
| 40° C. in | | | | | | | | | | | |
| water for 14 days | | | | | | | | | | | |
| 20° C. 65% | CF100% | CF100% | CF100% | CF100% | CF100% | CF100% | CF100% | CF100% | CF100% | CF100% | CF100% |
| RH × 7 days + | | | | | | | | | | | |
| 80° C. in | | | | | | | | | | | |
| oven for 14 days | | | | | | | | | | | |

| | Comparative Example | | | |
|---|---|---|---|---|
| | 1 | 2 | 3 | 4 |
| Urethane prepolymer 1 | 100 | 100 | 100 | 100 |
| Adduct 7 | 1.8 | | | |
| Adduct 8 | | 1.8 | | |
| Adduct 9 | | | 1.8 | |
| Adduct 10 | | | | 3.6 |
| Carbon black | 100 | 100 | 100 | 100 |
| Isononyl phthalate | 45 | 45 | 45 | 45 |
| Dioctyltin dilaurate | 0.005 | 0.005 | 0.005 | 0.005 |
| Dimethylaminoethylmorpholine | 0.02 | 0.02 | 0.02 | 0.02 |
| Adhesion | | | | |
| 20° C. 65% RH × 7 days | CF100% | CF100% | CF85% | CF10% |
| | | | AF15% | AF90% |
| 20° C. 65% RH × 7 days + | CF100% | CF100% | CF100% | CF40% |
| 40° C. in water for 14 days | | | | AF60% |
| 20° C. 65% RH × 7 days + | CF80% | CF85% | CF65% | CF50% |
| 80° C. in oven for 14 days | AF20% | AF15% | AF35% | AF50% |

From the results shown in Table 2, it was revealed that the polyurethane compositions of Examples 1-30 had high adhesion to plate glass. Further it was revealed that no loss of adhesion after 14 days of thermal aging in an oven at 80° C. proved excellent heat-resistant adhesion of the compositions.

In addition, the polyurethane compositions of Examples 1-30 exhibited curability and antifoaming property equivalent or superior to those obtained by Comparative Examples.

As described above, the inventive polyurethane compositions exhibit excellent adhesion to glass, metals, plastics, coated steel plates, etc. even without using a primer and further exhibit excellent heat-resistant adhesion. Therefore, the inventive polyurethane compositions are very useful as sealing materials such as those for automobiles, coating materials for construction, etc.

What is claimed is:

1. An one-pack moisture curable polyurethane composition comprising:
a compound A, which is a reaction product of a polyisocyanate having at least one member selected from the group consisting of a biuret group and an isocyanurate group with a secondary aminoalkoxysilane having an aromatic ring directly bonded to the nitrogen atom thereof, represented by formula (1) shown below 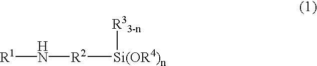
(wherein R¹ is an aromatic residue; R² is an alkylene group, which may be branched, having 1 to 18 carbon atoms; R³ and R⁴ are independently an alkyl group, which may be branched, having 1 to 18 carbon atoms; n is an integer of from 1 to 3, provided that plural (R³)s or (R⁴)s may be the same or different) and which has at least one isocyanate group and at least one hydrolyzable alkoxysilyl group in one molecule and which has an average molecular weight of below 2,000; and
a urethane prepolymer B having an average molecular weight of 2,000 or more and having an isocyanate group.

2. The one-pack moisture curable polyurethane composition according to claim 1, wherein the composition contains 0.1 to 15 parts by weight of the compound A per 100 parts by weight of the urethane prepolymer B.
